(19) United States
(12) Patent Application Publication
(10) Pub. No.: US 2026/0233621 A1
(43) Pub. Date: Aug. 13, 2026

(54) MOTOR CONTROLLER AND RAILROAD VEHICLE DRIVING SYSTEM

(71) Applicant: Mitsubishi Electric Corporation, Chiyoda-ku, Tokyo (JP)

(72) Inventors: Tomohiro KOJIYA, Tokyo (JP); Kazushi HORIE, Tokyo (JP)

(73) Assignee: Mitsubishi Electric Corporation, Chiyoda-ku, Tokyo (JP)

(21) Appl. No.: 19/130,312

(22) PCT Filed: Jan. 5, 2023
(86) PCT No.: PCT/JP2023/000090

§ 371 Date: May 15, 2025

(51) Int. Cl. B60L 15/32

(52) U.S. Cl. CPC B60L 15/32; B60L 2200/26; B60L 2220/42; B60L 2240/12; B60L 2240/421; B60L 2240/461

(57) ABSTRACT

A motor controller is installed on a railroad vehicle and collectively controls a plurality of propulsion motors that apply a driving force to the railroad vehicle and another railroad vehicle towed by the railroad vehicle. The railroad vehicle includes a continuously variable transmission that is interposed between the propulsion motor and a wheel shaft of the railroad vehicle and enables to continuously change a transmission gear ratio that is a ratio of a motor speed that is a rotational speed of the propulsion motor, with respect to a wheel speed that is a speed of a wheel coupled to the wheel shaft. The motor controller performs first control for adjusting the transmission gear ratio to be instructed to the continuously variable transmission, based on wheel diameter information that is information regarding lengths of the plurality of wheels in a radial direction.

### FIELD

The present disclosure relates to a motor controller that collectively controls a plurality of propulsion motors installed on a railroad vehicle and to a railroad vehicle driving system including the motor controller.

### BACKGROUND

Conventionally, in a railroad vehicle driving system, a motor controller that controls a propulsion motor has collectively controlled a plurality of propulsion motors in units of two or four. In a collective method for collectively controlling the plurality of propulsion motors, it is possible to largely reduce a weight and a volume of a controller, as compared with an individual method for individually controlling the single propulsion motor by the single controller, and a vehicle weight can be largely reduced.

In a case where the plurality of propulsion motors are controlled in a collective method, voltages with the same frequency are applied to the plurality of propulsion motors under control. An output shaft of each propulsion motor is connected to a wheel via a joint device, a gear device, or the like. Since the wheel is scraped by friction with a rail or the like, a wheel diameter that is a length of the wheel in a radial direction become different between the wheels over time. Therefore, it is difficult to set the wheel diameters of the plurality of wheels to be the same during an operation of the railroad vehicle, a wheel diameter difference is inevitably caused between the plurality of wheels. The wheel diameter difference varies a rotational speed of the wheel between the wheels. Furthermore, the gear device for the railroad vehicle decelerates a rotational speed of the propulsion motor and transmits the rotational speed to the wheel, however, unlike a gear device for an automobile, a gear ratio is fixed. Therefore, the wheel diameter difference between the wheels causes a difference between rotational speeds of the output shafts of the respective propulsion motors.

Under the above technical background, Patent Literature 1 discloses an electric vehicle driving system that can individually control a rotational speed and a torque for each wheel shaft of a wheel, even in a state where a plurality of propulsion motors are connected to a common inverter in parallel. In this electric vehicle driving system, one planetary gear mechanism including an auxiliary motor is provided between each propulsion motor and each joint. The electric vehicle driving system individually controls a rotational speed of each auxiliary motor by the planetary gear mechanism so that an influence of a wheel diameter difference does not appear in a rotational speed of an output shaft.

### CITATION LIST

### Patent Literature

Patent Literature 1: Japanese Patent Application Laid-open No. 2013-258819

### SUMMARY OF INVENTION

### Problem to be Solved by the Invention

However, with the technique in Patent Literature 1, it is necessary to add an auxiliary motor and a planetary gear mechanism, and there is a problem that a size of the device increases. A motor controller that controls a propulsion motor is often installed under a floor of a railroad vehicle. However, a space under the floor is limited, and there is often no sufficient space to additionally provide a device such as the auxiliary motor or the planetary gear mechanism.

The present disclosure has been made in view of the above, and an object of the present disclosure is to obtain a motor controller that collectively controls a plurality of propulsion motors, while preventing an increase in a size of a device.

### Means to Solve the Problem

To solve the above problems and achieve the object, a motor controller according to the present disclosure is installed on a railroad vehicle and is configured to collectively control a plurality of propulsion motors that apply a driving force to the railroad vehicle and another railroad vehicle towed by the railroad vehicle. The railroad vehicle includes a continuously variable transmission interposed between the propulsion motor and a wheel shaft of the railroad vehicle. The continuously variable transmission is configured to continuously change a transmission gear ratio as a ratio of a motor speed that is a rotational speed of the propulsion motor, with respect to a wheel speed that is a speed of a wheel coupled to the wheel shaft. The motor controller is configured to perform a first control for adjusting the transmission gear ratio to be instructed to the continuously variable transmission, based on wheel diameter information that is information regarding lengths of a plurality of the wheels in a radial direction.

### Effects of the Invention

According to a motor controller according to the present disclosure, it is possible to achieve an effect of collectively controlling a plurality of propulsion motors, while suppressing an increase in a size of a device.

### BRIEF DESCRIPTION OF DRAWINGS

FIG. 1 is a diagram illustrating an exemplary schematic configuration of a railroad vehicle driving system including a motor controller according to a first embodiment.

FIG. 2 is a diagram illustrating an exemplary configuration of a carriage on which a propulsion motor to be controlled by the motor controller according to the first embodiment is installed.

FIG. 3 is a diagram illustrating an image of an operation of a transmission gear ratio instructor included in the railroad vehicle driving system according to the first embodiment.

FIG. 4 is a diagram for explaining an effect of the railroad vehicle driving system according to the first embodiment.

FIG. 5 is a block diagram illustrating an example of a hardware configuration for implementing a control function of the motor controller according to the first embodiment.

FIG. 6 is a block diagram illustrating another example of the hardware configuration for implementing the control function of the motor controller according to the first embodiment.

FIG. 7 is a diagram for explaining an operation of a main part of a motor controller according to a second embodiment.

FIG. 8 is a flowchart illustrating a flow of control by the motor controller according to the second embodiment.

FIG. 9 is a first diagram for explaining a behavior by the control of the flow illustrated in FIG. 8.

FIG. 10 is a second diagram for explaining the behavior by the control of the flow illustrated in FIG. 8.

FIG. 11 is a third diagram for explaining the behavior by the control of the flow illustrated in FIG. 8.

### DESCRIPTION OF EMBODIMENTS

Hereinafter, a motor controller and a railroad vehicle driving system according to embodiments of the present disclosure will be described in detail with reference to the accompanying drawings. Note that, in the accompanying drawings, for easy understanding, there is a case where a scale of each member is different from an actual scale. Furthermore, in the following description, a plurality of components of the same type are denoted with a subscripted reference. However, in a case where the individual components are not distinguished from each other, the notation of the subscript is appropriately omitted.

### First Embodiment

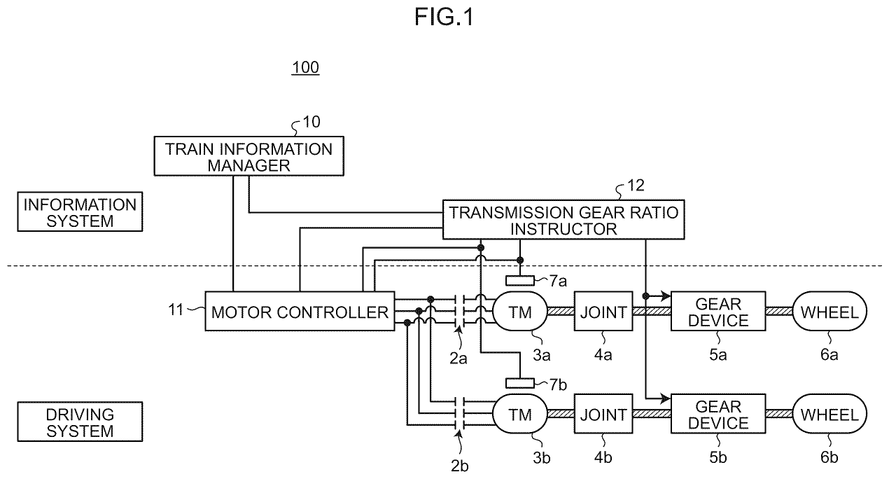

FIG. 1 is a diagram illustrating an exemplary schematic configuration of a railroad vehicle driving system 100 including a motor controller 11 according to a first embodiment. The railroad vehicle driving system 100 is a system that is installed on a railroad vehicle that travels by electric power supplied from an overhead line (not illustrated) and applies a driving force to the railroad vehicle on which a driving device is installed and another railroad vehicle towed by the railroad vehicle.

Components of the railroad vehicle driving system 100 can be divided into an information system and a driving system. The information system includes a train information manager 10 and a transmission gear ratio instructor 12. Furthermore, the driving system includes the motor controller 11 and propulsion motors 3a and 3b, as main components. The propulsion motors 3a and 3b are three-phase motors that apply a propulsive force to a railroad vehicle. Note that, although not illustrated, the motor controller 11 includes a filter capacitor that smooths an overhead line voltage applied from the overhead line, an inverter that converts a DC voltage smoothed by the filter capacitor into a variable voltage or a variable frequency AC voltage, a control unit that controls an operation of the inverter, and the like.

The propulsion motors 3a and 3b are connected to the motor controller 11 respectively via opening/closing units 2a and 2b. The opening/closing unit 2a switches electrical opening and conduction between the motor controller 11 and the propulsion motor 3a, and the opening/closing unit 2b switches electrical opening and conduction between the motor controller 11 and the propulsion motor 3b.

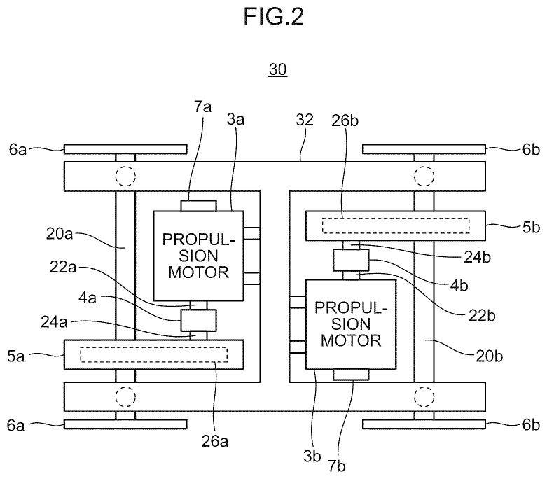

The propulsion motor 3a is connected to a wheel 6a via a joint 4a and a gear device 5a; and the propulsion motor 3b is connected to a wheel 6b via a joint 4b and a gear device 5b. FIG. 2 is a diagram illustrating an exemplary configuration of a carriage 30 on which the propulsion motors 3a and 3b to be controlled by the motor controller 11 according to the first embodiment is installed. In FIG. 2, an example is illustrated in which the propulsion motors 3a and 3b are installed on a carriage frame 32.

The propulsion motors 3a and 3b are diagonally arranged in the carriage frame 32. In the carriage frame 32, a wheel shaft 20a to which the wheel 6a is fitted and a wheel shaft 20b to which the wheel 6b is fitted are rotatably installed. The wheel shaft 20a is attached to the gear device 5a, and the wheel shaft 20b is attached to the gear device 5b. The gear device 5a is coupled to the propulsion motor 3a and the wheel shaft 20a, reduces the rotational speed of the propulsion motor 3a, and transmits the driving force to the wheel shaft 20a. Similarly, the gear device 5b is coupled to the propulsion motor 3b and the wheel shaft 20b, reduces a rotational speed of the propulsion motor 3b, and transmits the driving force to the wheel shaft 20b. A rotation shaft 22a of the propulsion motor 3a and a pinion shaft 24a of the gear device 5a are flexibly coupled by the joint 4a, and a rotation shaft 22b of the propulsion motor 3b and a pinion shaft 24b of the gear device 5b are flexibly coupled by the joint 4b.

The gear devices 5a and 5b respectively include continuously variable transmissions 26a and 26b. The continuously variable transmissions 26a and 26b are transmissions having functions similar to those of a continuously variable transmission (CVT) used for automobiles or the like in recent years. The continuously variable transmission 26a is connected to the wheel shaft 20a and the pinion shaft 24a. The continuously variable transmission 26a is interposed between the propulsion motor 3a and the wheel shaft 20a and is configured to be able to continuously change a transmission gear ratio that is a ratio of a motor speed with respect to a wheel speed. The wheel speed is a speed of a wheel coupled to the wheel shaft 20a, and the motor speed is a rotational speed of the propulsion motor 3a, that is, a rotation angular speed (rotation speed). The continuously variable transmission 26b is configured similarly to the continuously variable transmission 26a.

In the propulsion motors 3a and 3b, speed detectors 7a and 7b are respectively provided. The speed detectors 7a and 7b respectively detect the motor speeds which are the rotational speeds of the propulsion motors 3a and 3b. A detected value of the motor speed detected by the speed detectors 7a and 7b is input into the motor controller 11 and the transmission gear ratio instructor 12.

Note that, in the railroad vehicle driving system, sensorless control has been known which is a technique for estimating a motor speed or a rotor position of the propulsion motor 3 without using a speed sensor or a position sensor and controlling the propulsion motor 3 based on information regarding the estimated motor speed or the rotor position. Therefore, the railroad vehicle driving system to which the sensorless control is applied does not need the speed detector 7.

Returning to description of FIG. 1, the motor controller 11 is connected to the train information manager 10 and the transmission gear ratio instructor 12. The train information manager 10 is a device that manages train information of a train composed by a plurality of railroad vehicles. The train information is information transmitted in the train and includes wheel diameter information in this paper. The wheel diameter information is information regarding a length of the wheel 6 in a radial direction. The train information manager 10 manages the wheel diameter information in all the railroad vehicles belonging to the train. Furthermore, the train information manager 10 transmits the wheel diameter information to the motor controller 11 and the transmission gear ratio instructor 12 before the operation of the train. The motor controller 11 changes the transmission gear ratios of the wheels 6a and 6b for each of the wheels 6a and 6b, based on the wheel diameter information. The motor controller 11 transmits an instruction value of the transmission gear ratio for each of the wheels 6a and 6b to the transmission gear ratio instructor 12 and the transmission gear ratio instructor 12 transmits a control signal for controlling the transmission gear ratio, to the gear devices 5a and 5b so as to perform control for changing the transmission gear ratio.

The wheel diameter information transmitted to the motor controller 11 and the transmission gear ratio instructor 12 may be the wheel diameter information of: all the railroad vehicles belonging to the train; or only wheel diameter information regarding the wheel 6 of the carriage 30 on which the propulsion motor 3 is installed under the control of the motor controller 11 and the transmission gear ratio instructor 12. Furthermore, the wheel diameter information may be transmitted to only one of the motor controller 11 and the transmission gear ratio instructor 12. Note that, in a case where the wheel diameter information is stored only in the motor controller 11, the instruction value of the transmission gear ratio is calculated by the motor controller 11. In a case of this configuration, the transmission gear ratio instructor 12 receives information regarding the instruction value of the transmission gear ratio output from the motor controller 11 and controls the continuously variable transmissions 26a and 26b based on the received instruction value. Furthermore, in a case where the wheel diameter information is stored only in the transmission gear ratio instructor 12, the instruction value of the transmission gear ratio is calculated by the transmission gear ratio instructor 12.

Note that, in FIG. 1, the transmission gear ratio instructor 12 is configured as a component of the information system separately from the motor controller 11, but the transmission gear ratio instructor 12 may be configured as a component in the motor controller 11. In a case of this configuration, it is possible to obtain an effect that the railroad vehicle driving system 100 can be constructed without additionally providing a new device.

On the other hand, since the transmission gear ratio instructor 12 is the component of the information system and can be configured compactly, the transmission gear ratio instructor 12 can be arranged below a seat of the railroad vehicle or the like. Therefore, even if the transmission gear ratio instructor 12 is configured as different components from the motor controller 11, it is considered that a problem of securing an installation space hardly occurs. In a case where the transmission gear ratio instructor 12 and the motor controller 11 are different components, a degree of freedom of arrangement increases. Therefore, it is possible to arrange the transmission gear ratio instructor 12 and the motor controller 11 at desired positions in the railroad vehicle. As a result, as compared with a case where the transmission gear ratio instructor 12 is configured in the motor controller 11, an effect is obtained that a length of connection wiring for connecting the transmission gear ratio instructor 12 and the gear device 5 can be shortened.

Note that, in FIG. 1, a configuration is illustrated in which the single motor controller 11 collectively controls the two propulsion motors 3a and 3b. However, the present disclosure is not limited to this configuration. The motor controller 11 may collectively control three or more multiple propulsion motors 3.

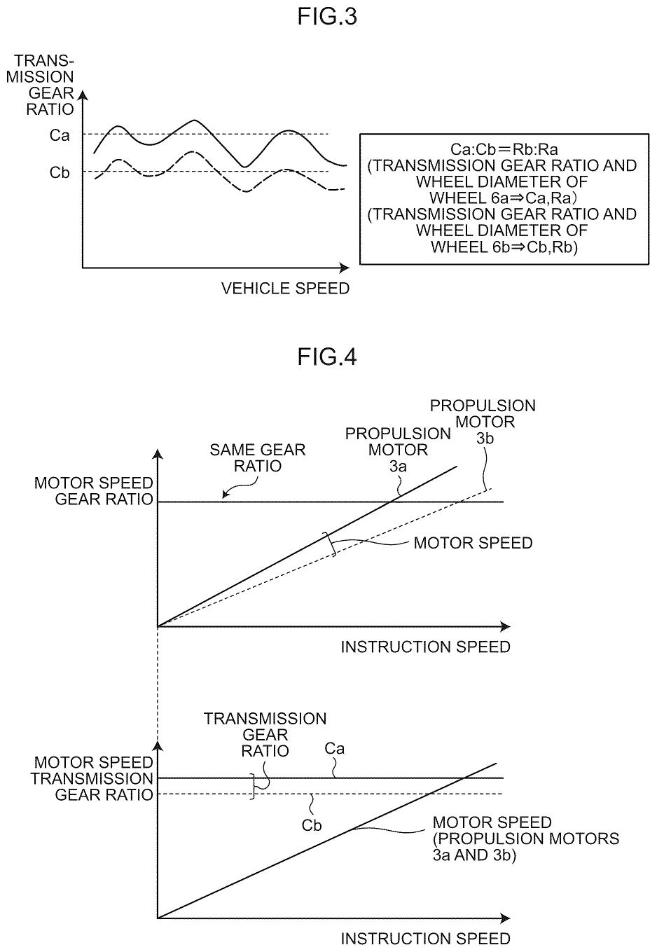

FIG. 3 is a diagram illustrating an image of an operation of the transmission gear ratio instructor 12 included in the railroad vehicle driving system 100 according to the first embodiment. In FIG. 3, the horizontal axis indicates a vehicle speed, and the vertical axis indicates a transmission gear ratio. The vehicle speed is a traveling speed of a railroad vehicle and is synonymous with the wheel speed. Ca is a transmission gear ratio to be instructed to the continuously variable transmission 26a connected to the wheel 6a, and a transmission gear ratio Cb is a transmission gear ratio to be instructed to the continuously variable transmission 26b connected to the wheel 6b. Furthermore, Ra is a wheel diameter of the wheel 6a, and Rb is a wheel diameter of the wheel 6b.

As described above, the gear devices 5a and 5b respectively include the continuously variable transmissions 26a and 26b. Therefore, the transmission gear ratios Ca and Cb used to control the gear devices 5a and 5b are continuously changed as illustrated. Furthermore, as illustrated in FIG. 3, even in a case where the vehicle speed is changed, the transmission gear ratios Ca and Cb are changed so that a ratio between the transmission gear ratios Ca and Cb is set to have a reciprocal ratio of the wheel diameters Ra and Rb, that is, Ca:Cb=Rb:Ra.

FIG. 3 is an example of a case where the wheel diameter Rb is longer than the wheel diameter Ra. In a case where the rotational speeds of the propulsion motors 3a and 3b are the same in a case where the wheel diameter Rb is longer than the wheel diameter Ra, the rotational speed of the wheel 6b is larger than the rotational speed of the wheel 6a. Therefore, in a case where the wheel diameter Rb is longer than the wheel diameter Ra, the transmission gear ratios Ca and Cb are set to have the reciprocal ratio of the wheel diameters Ra and Rb. As a result, the rotational speeds of the propulsion motors 3a and 3b are controlled to be the same, and at the same time, the rotational speeds of the wheels 6a and 6b are controlled to be the same.

As described above, the motor controller 11 according to the first embodiment performs control for adjusting the ratio of the transmission gear ratios Ca and Cb to be instructed to the continuously variable transmissions 26a and 26b, based on the wheel diameter information that is the information regarding the lengths of the wheels 6a and 6b in the radial direction. In this paper, this control may be appropriately referred to as a “first control”.

FIG. 4 is a diagram for explaining an effect of the railroad vehicle driving system 100 according to the first embodiment. In the description of FIG. 4, it is assumed that the propulsion motors 3a and 3b are induction motors.

On an upper side of FIG. 4, an operation example in a case where the single motor controller according to a conventional the related art collectively controls the propulsion motors 3a and 3b is illustrated. In the figure on the upper side, the horizontal axis indicates an instruction speed, and the vertical axis indicates a motor speed and a gear ratio. The gear ratio is a ratio of the number of teeth of a large gear that is provided in the wheel shaft 20 and meshes with a small gear, with respect to the number of teeth of the small gear provided in the pinion shaft 24, in a configuration of a conventional carriage, and is the same in the gear devices 5a and 5b. Therefore, in a case where there is a wheel diameter difference between the wheels 6a and 6b, the motor speeds of the propulsion motors 3a and 3b need to be different. Furthermore, if the instruction speed increases, a difference in the motor speed increases. Therefore, unless the wheel diameter difference between the wheels 6a and 6b is strictly managed, it is difficult to collectively control the propulsion motors 3a and 3b.

On a lower side of FIG. 4, an operation example in a case where the single motor controller 11 according to the first embodiment collectively controls the propulsion motors 3a and 3b is illustrated. In the figure on the lower side, the horizontal axis indicates an instruction speed, and the vertical axis indicates a motor speed and a transmission gear ratio. Conditions of the wheel diameters Ra and Rb are similar to those in FIG. 3, and it is assumed that the transmission gear ratios Ca and Cb be set to have the reciprocal ratio of the wheel diameters Ra and Rb. As illustrated, the motor speed is linearly changed in accordance with an increase in the instruction speed. However, since the transmission gear ratios Ca and Cb are appropriately set according to the wheel diameters Ra and Rb, if the motor speeds of the propulsion motors 3a and 3b are controlled to be the same, the wheel speeds of the wheels 6a and 6b can be set to be the same.

In a case where the propulsion motors 3a and 3b are induction motors, it is possible to collectively control the propulsion motors 3a and 3b, by using a slip peculiar to the induction motor. However, in a case where the slip is used, a frequency of a motor applied voltage is the same for the propulsion motors 3a and 3b, while a slip amount is different between the propulsion motors 3a and 3b. Therefore, a difference in an impedance is caused. This difference in the impedance causes a current difference between the propulsion motors 3a and 3b. This current difference causes a torque difference between the propulsion motors 3a and 3b. In a case where there is the torque difference and the torque is excessive, there is a possibility that the wheel shaft 20 to which the excessive torque is applied idles or slides. Furthermore, when an excessive current flows in a specific propulsion motor 3 due to the current difference, there is a possibility that the specific propulsion motor 3 is abnormally heated. To prevent these phenomena, it is necessary to suppress the wheel diameter difference within a certain range, which has been a constraint for railroad operators.

In a case where the wheel diameter difference is strictly managed, the railroad operator has needed to select a wheel diameter to be used, while considering that the wheel diameter difference between the wheel shafts in the same carriage or the same vehicle becomes as small as possible. Furthermore, it has been necessary for the railroad operator to have spare parts of the wheels more than necessary, perform a work for cutting the wheel more than necessary, and set the wheel diameter difference within a prescribed value, even if a life of the wheel is shortened. On the other hand, when the method in the first embodiment is used, it is not necessary to select the wheel diameter to be used. Therefore, it is not necessary to have the spare parts of the wheels more than necessary, and in addition, it is not necessary to cut the wheel more than necessary. As a result, an effect can be obtained that cost regarding the spare parts of the wheels of the railroad vehicle and cost required for a maintenance work of the wheels of the railroad vehicle can be largely reduced.

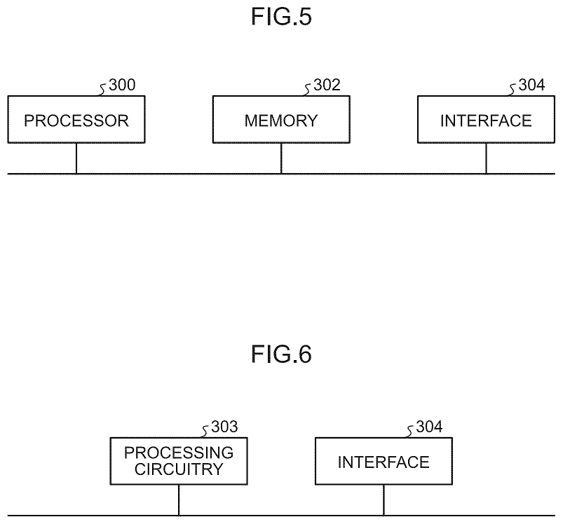

Next, a hardware configuration for implementing a control function of the motor controller 11 according to the first embodiment described above will be described with reference to the drawings in FIGS. 5 and 6. FIG. 5 is a block diagram illustrating an example of the hardware configuration for implementing the control function of the motor controller 11 according to the first embodiment. FIG. 6 is a block diagram illustrating another example of the hardware configuration for implementing the control function of the motor controller 11 according to the first embodiment.

In a case where some of or all of the control functions of the motor controller 11 according to the first embodiment are implemented, as illustrated in FIG. 5, a configuration can be used that includes a processor 300 that performs calculations, a memory 302 that saves a program read by the processor 300, and an interface 304 that inputs and outputs signals.

The processor 300 is calculation means. The processor 300 may be calculation means referred to as a microprocessor, a microcomputer, a central processing unit (CPU), or a digital signal processor (DSP). Furthermore, as the memory 302, a nonvolatile or a volatile semiconductor memory such as a random access memory (RAM), a read only memory (ROM), a flash memory, an erasable programmable ROM (EPROM), or an electrically EPROM (EEPROM) (registered trademark), a magnetic disk, a flexible disk, an optical disk, a compact disk, a mini disk, or a digital versatile disc (DVD) can be exemplified. Note that, in the memory 302, as a combination of the RAM and the EEPROM, the plurality of storage devices may be combined.

The memory 302 stores a program that executes the control function of the motor controller 11 according to the first embodiment. The processor 300 can execute the above processing by: receiving needed information via the interface 304; executing the program stored in the memory 302 by the processor 300; and referring to a table stored in the memory 302 by the processor 300. A calculation result by the processor 300 can be stored in the memory 302.

Furthermore, in a case where some of the control functions of the motor controller 11 according to the first embodiment are implemented, a processing circuitry 303 illustrated in FIG. 6 can be used. The processing circuitry 303 corresponds to: a single circuit; a composite circuit; an application specific integrated circuit (ASIC); a field-programmable gate array (FPGA); or a combination thereof. Information input to the processing circuitry 303 and information output from the processing circuitry 303 can be obtained via the interface 304.

Note that a part of the processing of the control function of the motor controller 11 according to the first embodiment may be executed by the processing circuitry 303, and processing that is not executed by the processing circuitry 303 may be executed by the processor 300 and the memory 302.

As described above, the motor controller according to the first embodiment performs the first control for adjusting the transmission gear ratio to be instructed to the continuously variable transmission, based on the wheel diameter information that is the information regarding the lengths of the plurality of wheels in the radial direction. Since the transmission gear ratio to be instructed to the continuously variable transmission included in the gear device is appropriately set according to the wheel diameter difference between the plurality of wheels by the first control, the motor speed can be controlled to be the same between the plurality of propulsion motors, and the wheel speed can be set to be the same between the plurality of wheels. As a result, it is possible to implement the motor controller that collectively controls the plurality of propulsion motors, while suppressing an increase in a size of the device.

Furthermore, the railroad vehicle driving system according to the first embodiment can be implemented by installing the motor controller on the railroad vehicle and installing the gear device including the continuously variable transmission on the carriage where the propulsion motor is installed. In a case where the railroad vehicle driving system according to the first embodiment is used, the railroad operator does not need to select the wheel diameter to be used. Therefore, it is not necessary to have the spare parts of the wheels more than necessary, and in addition, it is not necessary to cut the wheel more than necessary. As a result, the railroad operator can enjoy the effect that the cost regarding the spare parts of the wheels of the railroad vehicle and the cost required for the maintenance work of the wheel of the railroad vehicle can be largely reduced.

Note that the wheel diameter information needed when the first control is performed may be stored in the motor controller or may be stored in the train information manager that manages the train information of the train composed by the plurality of railroad vehicles. Furthermore, on the railroad vehicle, the transmission gear ratio instructor that receives the information regarding the instruction value of the transmission gear ratio output from the motor controller may be installed. In a case where the transmission gear ratio instructor is installed on the railroad vehicle, the instruction value of the transmission gear ratio output from the motor controller is instructed to the continuously variable transmission via the transmission gear ratio instructor. In a case where the transmission gear ratio instructor is assumed as an internal component of the motor controller, it is possible to enjoy an effect that the railroad vehicle driving system can be constructed, without additionally providing a new device. Furthermore, in a case where the transmission gear ratio instructor is set as an external component of the motor controller, the degree of freedom of the arrangement increases, and the transmission gear ratio instructor can be arranged at a desired position of the railroad vehicle. As a result, as compared with a case where the transmission gear ratio instructor is set as the internal component of the motor controller, it is possible to enjoy an effect that the length of the connection wiring for connecting the transmission gear ratio instructor and the gear device can be shortened.

### Second Embodiment

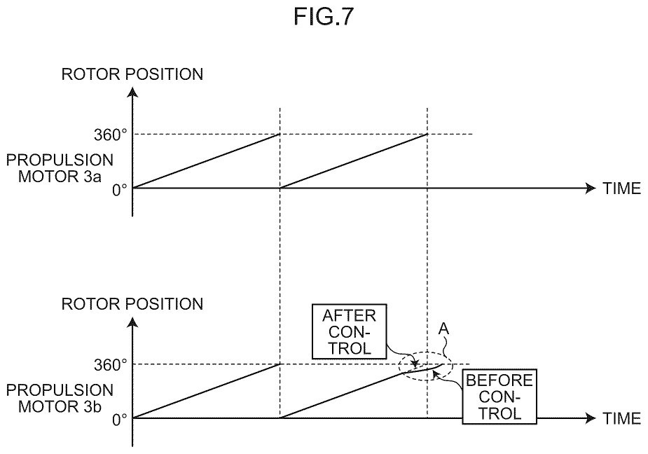

FIG. 7 is a diagram for explaining an operation of a main part of the motor controller 11 according to a second embodiment. A waveform indicating the rotor position of the propulsion motor 3a is illustrated on an upper side of FIG. 7, and a waveform indicating the rotor position of the propulsion motor 3b is illustrated on a lower side of FIG. 7. The horizontal axis in FIG. 7 indicates time. Furthermore, on the lower side in FIG. 7, a state is illustrated where the rotor position of the propulsion motor 3b indicates a behavior different from a normal behavior, in a portion A indicated by a dashed ellipse. In the portion A, a solid line indicates a behavior before control, and a broken line indicates a behavior after the control.

At the time of rainy weather, at the time of traveling a curve, or the like, an adhesion coefficient of the wheel 6 is lowered, and the railroad vehicle may idle or slide. In a case where the railroad vehicle idles or slides, a control for suppressing these is performed. In a case of an individual method, rotation of each wheel shaft 20 can be individually and finely controlled. For example, in a case where the wheel 6 idles or slides, it is possible to prevent idling or sliding by transiently finely adjusting an output of the corresponding propulsion motor 3 from a setting value, according to a state of each wheel 6. On the other hand, in a case of a collective method, in a case where the wheel diameter difference between the plurality of wheels 6 is large, the conventional motor controller cannot individually control the output of the propulsion motor 3. Therefore, it is difficult to finely control idling or sliding.

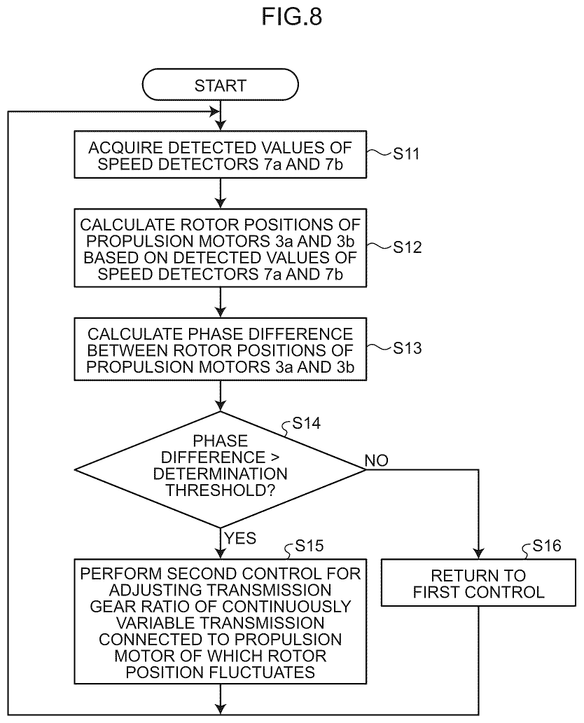

To cope with the above problem, the motor controller 11 according to the second embodiment performs control according to a flow illustrated in FIG. 8. FIG. 8 is a flowchart illustrating a flow of the control by the motor controller 11 according to the second embodiment.

The motor controller 11 acquires the detected values of the speed detectors 7 a and 7b (step S11). Next, the motor controller 11 calculates the rotor positions of the propulsion motors 3a and 3b based on the detected values of the speed detectors 7a and 7b (step S12) and calculates a phase difference between the rotor positions of the propulsion motors 3a and 3b (step S13). The motor controller 11 compares the phase difference between the rotor positions calculated in step S13 with a determination threshold (step S14).

In a case where the phase difference is larger than the determination threshold (step S14, Yes), the motor controller 11 performs second control for adjusting the transmission gear ratio of the continuously variable transmission 26 connected to the propulsion motor 3 of which the rotor position fluctuates (step S15). The “adjustment of the transmission gear ratio” here means to adjust the transmission gear ratio of the continuously variable transmission 26 in a direction in which the phase difference of the rotor positions decreases. When the processing in step S15 ends, the procedure returns to step S11, and the processing from step S11 is repeated.

In a case where the phase difference is equal to or less than the determination threshold (step S14, No), the procedure returns to the first control described in the first embodiment (step S16). When the processing in step S16 ends, the procedure returns to step S11, and the processing from step S11 is repeated.

Note that, in the determination processing in step S14, a case where the phase difference and the determination threshold are equal to each other is determined as “No”, the case may be determined as “Yes”. That is, a case where the phase difference and the determination threshold are equal to each other may be determined as “Yes” or “No”.

According to the control of the flow illustrated in FIG. 8, the rotor position of the propulsion motor 3b is controlled in a direction of eliminating a displacement of the rotor position, as indicated by the broken line in the portion A in FIG. 7.

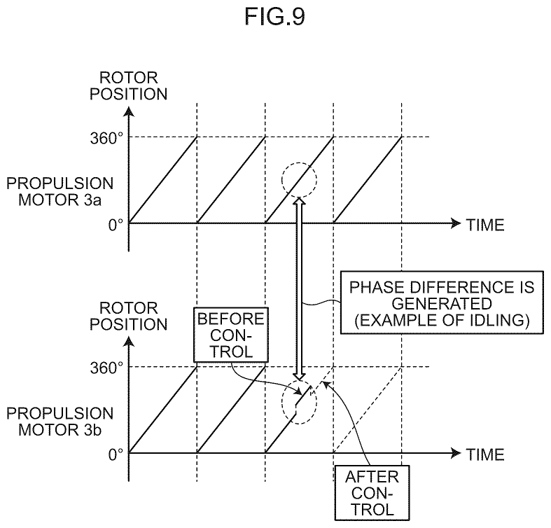

FIG. 9 is a first diagram for explaining the behavior by the control of the flow illustrated in FIG. 8. In FIG. 9, on both of an upper side and a lower side, a temporal change waveform of the rotor position is illustrated, as in FIG. 8.

In FIG. 9, an example of a case where the wheel 6b connected to the propulsion motor 3b idles, at a portion indicated by a dashed ellipse on the lower side is illustrated. The solid line indicates the behavior before the control, and the broken line indicates the behavior after the control. In a case where the wheel 6b idles, the phase difference exceeding the determination threshold is generated between the rotor position of the propulsion motor 3b that drives the wheel 6b and the rotor position of the propulsion motor 3a that drives the wheel 6a. Therefore, by performing the control illustrated in FIG. 8, the transmission gear ratio of the continuously variable transmission 26b on the side of the propulsion motor 3b is adjusted and controlled in the direction in which the displacement of the rotor position is eliminated as indicated by the broken line. As a result, the displacement of the rotor position caused by the idling of the wheel 6b is eliminated.

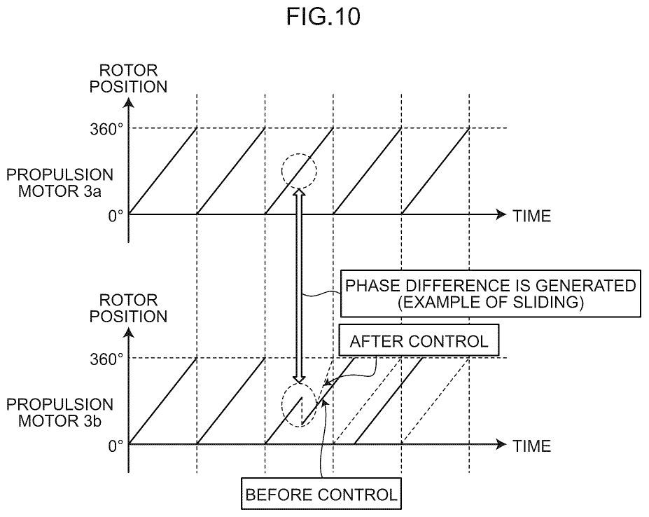

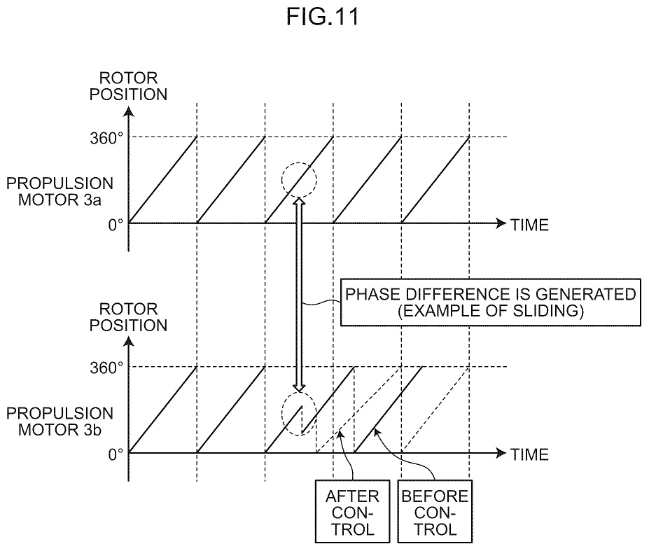

FIG. 10 is a second diagram for explaining the behavior by the control of the flow illustrated in FIG. 8. Furthermore, FIG. 11 is a third diagram for explaining the behavior by the control of the flow illustrated in FIG. 8.

In FIG. 10, an example of a case where the wheel 6b connected to the propulsion motor 3b slides, in a portion indicated by a dashed ellipse on the lower side is illustrated. The solid line indicates the behavior before the control, and the broken line indicates the behavior after the control. In a case where the wheel 6b slides, the phase difference exceeding the determination threshold is generated between the rotor position of the propulsion motor 3b that drives the wheel 6b and the rotor position of the propulsion motor 3a that drives the wheel 6a. Therefore, by performing the control illustrated in FIG. 8, the transmission gear ratio of the continuously variable transmission 26b on the side of the propulsion motor 3b is adjusted and controlled in the direction in which the displacement of the rotor position is eliminated as indicated by the broken line. As a result, the displacement of the rotor position caused by the slide of the wheel 6b is eliminated.

In FIG. 10, an example is illustrated in which the phase difference is eliminated, by increasing a speed of an advancing phase of the rotor position on the side of the propulsion motor 3b, in a case where the phase difference determined as sliding is detected. However, the present disclosure is not limited to this. As illustrated in FIG. 11, by slowing the advancing phase of the rotor position on the side of the propulsion motor 3b, the phase difference may be eliminated.

As described above, the motor controller according to the second embodiment calculates the phase difference of the rotor position of the propulsion motor, based on the detected value of the speed detector included in the propulsion motor and performs the second control for adjusting the transmission gear ratio based on the phase difference of the rotor position. The motor controller performs the second control in a case where the phase difference of the rotor position is larger than the determination threshold, and the transmission gear ratio of the continuously variable transmission connected to the propulsion motor of which the rotor position fluctuates is adjusted. Furthermore, in a case where the phase difference of the rotor position is lowered to be equal to or less than the determination threshold, the procedure returns to the first control. According to the first and second control, in addition to the effect of the first embodiment, an effect is obtained that sliding or idling that is likely to occur due to the wheel diameter difference can be quickly eliminated.

Furthermore, the railroad vehicle driving system according to the second embodiment can be implemented by installing the gear device including the continuously variable transmission described in the first embodiment on the carriage where the propulsion motor is installed and installing the motor controller described in the second embodiment on the railroad vehicle. In a case where the railroad vehicle driving system according to the second embodiment is used, the railroad operator can enjoy the effect of the second embodiment that the idling or the sliding can be quickly eliminated, in addition to the effect of the first embodiment.

Note that the method according to the second embodiment is particularly effective in a case where the propulsion motors 3a and 3b are synchronous motors. However, it is not intended to hinder application to the induction motor. Even if the propulsion motors 3a and 3b are induction motors, it is possible to enjoy the effect according to the second embodiment.

The configurations illustrated in the above embodiments indicate examples and can be combined with other known techniques. Furthermore, the embodiments can be combined with each other, and some configurations can be partially omitted or changed without departing from the scope of the present disclosure.

### REFERENCE SIGNS LIST

2a, 2b opening/closing unit; 3, 3a, 3b propulsion motor; 4a, 4b joint; 5, 5a, 5b gear device; 6, 6a, 6b wheel; 7, 7a, 7b speed detector; 10 train information manager; 11 motor controller; 12 transmission gear ratio instructor; 20, 20a, 20b wheel shaft; 22a, 22b rotation shaft; 24, 24a, 24b pinion shaft; 26, 26a, 26b continuously variable transmission; 30 carriage; 32 carriage frame; 100 railroad vehicle driving system; 300 processor; 302 memory; 303 processing circuitry; 304 interface.

1. A motor controller that is installed on a railroad vehicle and configured to collectively control a plurality of propulsion motors that apply a driving force to the railroad vehicle and another railroad vehicle towed by the railroad vehicle, wherein
the railroad vehicle:
includes a continuously variable transmission interposed between the propulsion motor and a wheel shaft of the railroad vehicle; and
the continuously variable transmission is configured to continuously change a transmission gear ratio as a ratio of a motor speed that is a rotational speed of the propulsion motor, with respect to a wheel speed that is a speed of a wheel coupled to the wheel shaft, wherein
the motor controller is configured to perform a first control for adjusting the transmission gear ratio to be instructed to the continuously variable transmission, based on wheel diameter information that is information regarding lengths of a plurality of the wheels in a radial direction.

2. The motor controller according to claim 1, wherein
in a case where the first control is performed, a ratio of the transmission gear ratio is adjusted so that rotational speeds of the plurality of propulsion motors become the same.

3. The motor controller according to claim 1, wherein
the wheel diameter information is stored in the motor controller.

4. The motor controller according to claim 1, wherein
a train information manager configured to manage train information of a train composed of a plurality of the railroad vehicles is installed on the railroad vehicle, and the wheel diameter information is transmitted from the train information manager to the motor controller and is stored in the motor controller.

5. The motor controller according to claim 1, wherein
the propulsion motor includes a speed detector configured to detect the rotational speed of the propulsion motor, and
the motor controller is configured to:
calculate a phase difference of rotor position of the propulsion motors based on a detected value of the speed detector; and
perform a second control for adjusting the transmission gear ratio based on the phase difference of the rotor position.

6. The motor controller according to claim 5, wherein
the motor controller is configured to:
perform the second control in a case where the phase difference of the rotor position is larger than a determination threshold; and
adjust a transmission gear ratio of the continuously variable transmission connected to the propulsion motor of which the rotor position fluctuates in the second control.

7. The motor controller according to claim 6, wherein
in a case where the phase difference of the rotor position is lowered to be equal to or less than the determination threshold, the procedure returns to the first control.

8. A railroad vehicle driving system comprising:
a plurality of propulsion motors to be installed on a railroad vehicle and configured to apply a driving force to the railroad vehicle and another railroad vehicle towed by the railroad vehicle;
a motor controller configured to collectively control the plurality of propulsion motors; and
a continuously variable transmission to be interposed between the propulsion motor and a wheel shaft of the railroad vehicle,
the continuously variable transmission is configured to change a transmission gear ratio as a ratio of a motor speed that is a rotational speed of the propulsion motor, with respect to a wheel speed that is a speed of a wheel coupled to the wheel shaft, wherein
the motor controller is configured to perform first control for adjusting the transmission gear ratio to be instructed to the continuously variable transmission, based on wheel diameter information that is information regarding a length of the wheel in a radial direction.

9. The railroad vehicle driving system according to claim 8, wherein
in a case of performing the first control, the motor controller is configured to adjust a ratio of the transmission gear ratio so that rotational speeds of the plurality of propulsion motors become the same.

10. The railroad vehicle driving system according to claim 8, wherein
the wheel diameter information is stored in the motor controller.

11. The railroad vehicle driving system according to claim 8, wherein
a train information manager configured to manage train information of a train composed of a plurality of the railroad vehicles is installed on the railroad vehicle, and the wheel diameter information is transmitted from the train information manager to the motor controller and is stored in the motor controller.

12. The railroad vehicle driving system according to claim 8, wherein
a transmission gear ratio instructor configured to receive information regarding an instruction value of the transmission gear ratio output from the motor controller is installed on the railroad vehicle, and
the transmission gear ratio instructor is configured to instruct the received instruction value of the transmission gear ratio to the continuously variable transmission.

13. The railroad vehicle driving system according to claim 8, wherein
the propulsion motor includes a speed detector configured to detect a rotational speed of the propulsion motor, and
the motor controller is configured to:
calculate a phase difference of a rotor position of the propulsion motor, based on a detected value of the speed detector; and
perform a second control for adjusting the transmission gear ratio based on the phase difference of the rotor position.

14. The railroad vehicle driving system according to claim 13, wherein
the motor controller is configured to:
perform the second control in a case where the phase difference of the rotor position is larger than a determination threshold; and
adjust, in the second control, a transmission gear ratio of the continuously variable transmission connected to the propulsion motor of which the rotor position fluctuates.

15. The railroad vehicle driving system according to claim 14, wherein
in a case where the phase difference of the rotor position is lowered to be equal to or less than the determination threshold, the motor controller is configured to return to the first control.
